(19) United States
(12) Patent Application Publication
(10) Pub. No.: US 2010/0039003 A1
(43) Pub. Date: Feb. 18, 2010

(54) ELECTROMOTIVE ACTUATING DRIVE

(75) Inventors: Dieter Palm, Werther (DE); Bernd Buchholz, Rahden (DE)

Correspondence Address: BARNES & THORNBURG LLP, 750-17TH STREET NW, SUITE 900, WASHINGTON, DC, 20006-4675, US

(73) Assignee: ELODRIVE GMBH, Minden (DE)

(21) Appl. No.: 12/440,111

(22) PCT Filed: Sep. 6, 2006
(86) PCT No.: PCT/EP06/08688

§ 371 Date: Sep. 1, 2009

(51) Int. Cl. H02K 11/00; F16K 31/05; F16H 37/00; H02K 7/10

(52) U.S. Cl. 310/68 A; 74/625; 310/68 B; 310/83

(57) ABSTRACT

An electric motor actuating drive for actuating elements designed such that the drive train, which is formed from spur gears, is not self-locking, and such that a braking spring is operatively connected to a gearbox stage upstream of the output-drive element of the drive train, such that, when the drive motor is disconnected, the actuating element is effectively prevented from being moved even when attempts are made to move it by external force or by extreme force. Furthermore, the actuating drive is in the form of a spring return and is equipped with a drive spring which is arranged such that the load on it is removed in the event of electrical power failure, and it therefore acts as a drive element. Furthermore, the electrical components are arranged in an end-face housing wall for a compact design.

### BACKGROUND AND SUMMARY

The invention relates to an electromotive actuating drive, preferably for actuating elements, for example flaps, valves and the like, which are to be pivoted. The drive has a housing of flat construction comprising at least two shell-like housing parts and in which at least one housing wall is fitted with electrical components, in which an electric motor and a drive train which reduces the motor rotation speed and is equipped with an output drive element is installed in the housing. The said drive train has a plurality of gear stages, a manual adjusting shaft for adjusting the output drive element and/or the actuating element which is coupled to the said output drive element. One of the gear stages is equipped with a brake element in such a way that at least that part of the drive train which leads from this gear stage to the output drive element is blocked from returning.

The electromotive actuating drives in question are used to adjust mechanical actuating elements in an extremely wide variety of embodiments, but preferably flaps in heating, ventilation and air-conditioning systems are driven in a controlled manner. The operating rotation speeds of the drive motors of the said actuating drives are relatively high, the speeds of the actuating elements to be driven or the rotation speeds of the output drive elements are relatively low, and so a plurality of gear stages which reduce the rotation speeds are also required.

The individual gear stages usually comprise two gear wheels with an extremely large ratio in terms of the number of teeth. For safety reasons, the actuating drives are provided with a force storage means which can be put into operation independently of electrical energy, in order to move the actuating element, which is connected to the actuating drive, into a specific position for example in the event of a power failure.

The drives have to be equipped with a manual adjusting shaft so that the output drive element and/or the actuating element, which is coupled to the said output drive element, can be moved into at least one predetermined end position which should preferably be approached with the electric motor switched on.

In a known actuating drive, the manual adjusting shaft is operatively connected to a brake spring which is inserted into a bushing. Whereas the brake spring is made to rotate by the electric motor during operation of the actuating drive, there is no friction between the brake spring and the bushing. A control part which comprises a control inner part and a control outer part is inserted into the brake spring. This control part expands the brake spring after the electric motor is switched off and thus effectively preventing return of the actuating element and, respectively, of the entire drive train by virtue of the braking torque which is produced.

This embodiment has proven successful per se, and so the electromotive actuating drive can fully fulfill the function.

However, forcible and unauthorized adjustment of the actuating element, for example by means of a tool, cannot be excluded. This may damage not only the actuating element but also the drive parts of the actuating drive. However, a particular disadvantage is that the basic setting of the actuating drive may be changed, and so the function is no longer available.

In order to solve this problem, it has been proposed to mount a double-acting freewheel in the drive train in combination with the output drive element. As a result of which, adjustment of the actuating element and, respectively, of the output drive element should no longer be possible. However, since a freewheel has a relatively large amount of play, adjustment of the actuating element and, respectively, of the output drive element is also still possible here.

The invention is based on the problem of designing an electromotive actuating drive of the type described in greater detail in the introduction such that it is ensured that, even in the event of a force acting on the actuating element and therefore also on the output drive element of the drive train, no adjustment of the actuating element and no return of the drive train is possible.

The set problem is solved by the combination of the non-self-locking drive train with a brake element which is operatively connected to a gear stage and with a force storage means for restoring the actuating element with simultaneous return of the drive train in the event of a power failure.

The electromotive actuating drive according to the invention is designed such that adjustment of the actuating element is possible during normal operation only when the electric motor is switched on. The direction of rotation of the electric motor can be reversed, so that the actuating element is adjusted in both directions by means of the electric motor. If, however, the electric motor is switched off, the actuating element remains in the respective position. Even if forces act on the actuating element, the actuating element remains in the respective position since the brake element is designed such that adjustment is not possible. However, in the event of a power failure, the force storage means is activated or relieved of load to move the actuating element into a predetermined position. According to the invention, the combination of the force storage means with the brake element is provided in the actuating drive. Furthermore, the brake element is not operatively connected to the manual adjusting shaft.

In principle, it is possible for the brake element to interact with one of the gear stages of the drive train. However, the torques to be transmitted are the greatest in the output drive range of this drive train. It is therefore necessary to absorb high levels of force.

In order to provide optimum conditions, the brake element is in the form of an expandable brake spring. The brake spring has a plurality of turns, and is operatively connected to a gear stage which is situated between the manual adjusting shaft and the output drive element of the drive train. The torque increases in each gear stage in the direction of the output drive element of the drive train. Since the spring which forms the brake element is now mounted in the region between the manual adjusting shaft and the output drive element, it can reliably lock the actuating element and, respectively, the output drive element. Further, the brake spring is to be coupled to the associated gear stage. As a result, the brake spring is simultaneously moved in accordance with the rotation speed of the gear stage when the electric motor is switched on and the drive parts are rotating. In order to achieve the braking effect, the brake spring has an associated non-rotatable sleeve, preferably to be inserted in the said sleeve. In order for the brake spring to be activated after the electric motor is switched off, the brake spring surrounds a control part in such a way that the brake spring can be expanded after the electric motor is switched off. This generates a holding force, so that a force fit is created between the brake spring and the bushing. This force fit causes the actuating element to remain in the respective position. A structurally simple solution is achieved when the control part comprises a control inner part and a control outer part which surrounds the said control inner part in an interlocking manner, and that the brake spring surrounds the control outer part. The control inner part and the control outer part interact in such a way that the brake spring expands after the electric motor is switched off and can freely contract again when it is switched on.

In order for a sufficiently high braking force to be achieved by expansion of the brake spring, provision the brake spring corresponds to the diameter of the gear wheel with the larger diameter of a gear stage. As a result, the diameter of the brake spring is considerably increased compared to previously known embodiments, and so the achieved braking torque is correspondingly high.

In the actuating drives under discussion, it is necessary for the adjustment path of the actuating element or of the output drive element of the drive train or the adjustment angle of the actuating element or of the output drive element of the drive train to be determined, so that, for example, a specific position of the actuating element can be reproduced. This is usually performed by a potentiometer. Since the actuating drives under discussion can be constructed with an extremely compact design, the output drive element of the drive train has a functionally associated potentiometer of flat construction. A potentiometer of this type is preferably a film potentiometer or a magnet potentiometer. As a result, the paths or the angles can be detected as actual values. Since the output drive element of the drive train can be driven in rotation, a rotary film potentiometer is used in a preferred embodiment.

As already mentioned, electrical components are installed on a housing wall. Cable glands, functional switches, actuating devices for auxiliary switches and potentiometers are preferred.

In order for these components to also be mounted such that the compact design is ensured in the case of the actuating drive under discussion, the electrical components are associated with an end-face housing wall arrangement.

The electrical components are now arranged close to one another in the end wall of the housing wall arrangement. As a result, the overall physical height is not increased. This is particularly advantageous since the actuating drives under discussion are installed in ventilation shafts and the like. The structure is simplified overall since the electrical components are now situated at relatively small distances from one another.

In a first embodiment, the electrical components are arranged in that end-face housing wall arrangement which adjoins the electric motor and is situated opposite the output drive element of the drive train. As a result, the connection between the electric motor and the power supply cable, for example, is particularly short. In addition, they are not disruptive in this end-face housing wall arrangement.

Mounting and any possible monitoring or repair work can be carried out in a particularly simple manner when the end-face housing wall arrangement is in the form of a cover which is detachably fixed to the remaining housing parts. This is performed, for example, by mechanical connection elements, preferably by screws.

If, depending on the design, the space adjoining the cover does not form a sufficiently large installation space, in a further refinement an intermediate piece is arranged between the cover and the remaining housing parts. The intermediate piece increases the length of the housing. This provides the further option of it being possible, depending on the design, to vary the length of the intermediate piece, that is to say intermediate pieces of different lengths are used for various fields of use.

Provision is made for cable glands, actuating devices for auxiliary switches and potentiometers, functional switches and, furthermore, also mechanical components such as ventilation stoppers to be arranged in the end-face housing wall arrangement.

On account of the different configurations of these electrical components, the electrical components can be fitted to and/or inserted in and/or integrally formed on the housing wall arrangement.

In a particularly advantageous manner, the remaining housing parts are of shell-like configuration and at least one housing part projects in the direction of the separating plane of the two housing parts in the region of the output drive element. As a result, a free space is created in order to connect the output drive element of the drive to a rod or some other drive part for an actuating member which is to be adjusted. However, in a preferred embodiment, the two housing parts project in the direction of the separating plane in the region of the output drive element of the drive train to the same extent. In a preferred embodiment, the output drive element of the drive train engages a centering and clamping apparatus, so that the centering and clamping apparatus follows the rotary movement of the output drive element and transmits this movement to the element leading to the actuating member.

The invention is explained below in greater detail with reference to the appended drawings

### BRIEF DESCRIPTION OF THE DRAWINGS

FIG. 1 shows an actuating drive according to the invention in a perspective illustration which shows the housing, and

FIG. 2 shows the actuating drive according to the invention with the housing cut open.

### DETAILED DESCRIPTION OF THE EMBODIMENTS

The actuating drive 10 according to the invention contains a housing, which is to be considered closed, and comprises two elongate and shell-like housing parts 11, 12 and an end cover 13 which is is detachably connected to the two housing parts 11, 12. This connection can be established, for example, by screws. The two housing parts 11, 12 are symmetrical and firmly connected to one another, for example likewise by screws or by latching elements. The separating plane of the two housing parts 11, 12 is identified by reference symbol 14. In a manner which is not illustrated in any detail, a drive motor and a drive train which has a plurality of gear stages are installed in the interior space bounded by the housing parts 11, 12.

A plurality of electrical components is arranged in the cover 13. Therefore, two functional switches 15, 16 are installed there. Furthermore, the cover 13 contains two cable terminals or connectors 17, 18 which are identified in the trade as high-strength cable terminals. An actuating device 19 for auxiliary switches and for a potentiometer is also arranged in the cover 13. Furthermore, a ventilation stopper 20 is also inserted through the cover 13.

The arrangement of these electrical components 15-20 is shown by way of example. The number and type of electrical components depends on the respective use.

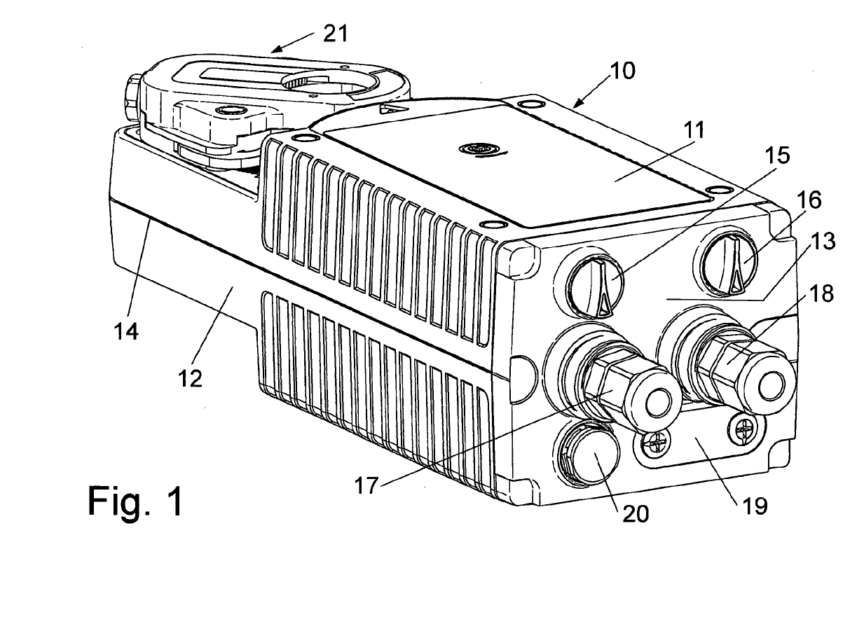

FIG. 1 shows that the arrangement of the electrical components in an end-face housing wall or in the cover 13 keeps the physical height of the actuating drive 10 as low as possible. This is advantageous particularly when the actuating drive 10 is mounted in a shaft or a similar tubular structure.

The drive motor (not illustrated) is situated in the interior of the housing parts 11, 12 adjoining the cover 13. If it is necessary for an installation space to be required for further functional parts, it is entirely possible for an intermediate piece (not illustrated) to be mounted between the end-face areas of the housing parts 11, 12 and the cover 13.

In the illustrated exemplary embodiment, the housing parts 11, 12 project at a reduced hight, on that side which is situated opposite the cover 13, in the direction of the separating plane 14. As a result, free spaces are created on both sides in order to accommodate a centering and clamping apparatus 21 (not explained in any detail). A rod, which is connected to an actuating member which is to be adjusted, can be fixed in this centering and clamping apparatus 21. The centering and clamping apparatus 21 itself is connected in an interlocking manner to the sleeve-like output drive element of the drive train. Projection of the two housing parts 11, 12 in the direction of the separating plane 14 provides the advantage that, with a continuous sleeve-like output drive element, the centering and clamping apparatus 21 can optionally be associated with one of the housing parts 11, 12.

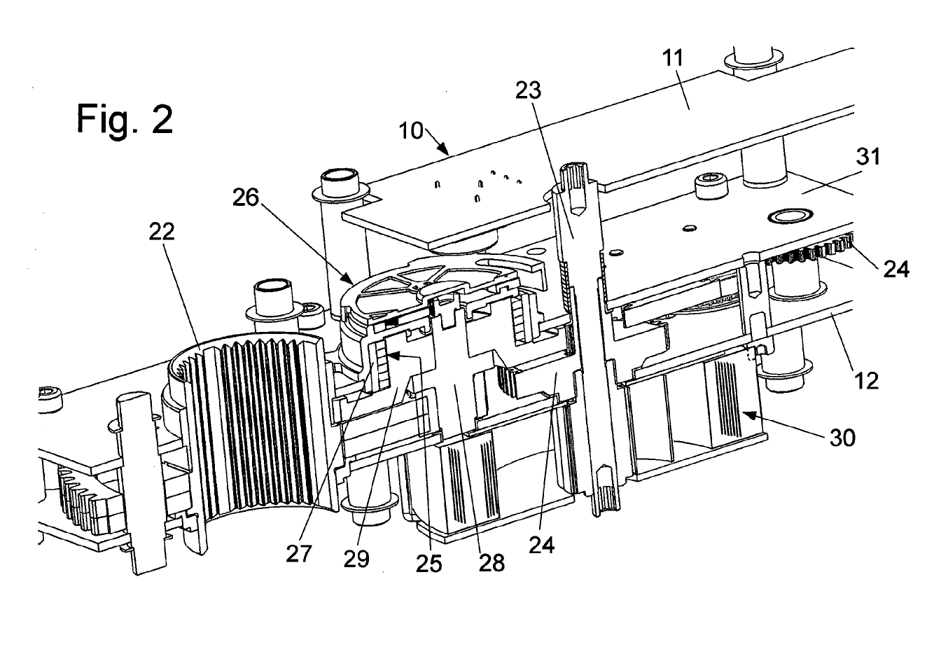

The housing which is formed from the housing parts 11, 12 is illustrated only indicatively in FIG. 2 for reasons concerning the illustration of the gear mechanism components. The drive train contains a rotationally drivable output drive element 22 which is in the form of a hollow bushing and is provided with an internal tooth system. The actuating element can be adjusted by a rod which is inserted in a manner which is not illustrated in any detail. The actuating drive 10 is equipped with a manual adjusting shaft 23 in order to be able to adjust the actuating element when the electric motor is switched off. The drive train contains a plurality of spur gears 24 which mesh with one another and form gear stages. Each gear stage contains two gear wheels which have different numbers of teeth and rotate at the same rotation speed. This reduces the motor speed to the output drive element 22. As is clearly shown in FIG. 2, a gear stage with which a brake spring 25 comprising a plurality of turns is functionally associated is connected upstream of the output drive element 22. The brake spring 25 is situated within a pot-like housing 26. The brake spring 25 is coupled to the associated gear stage such that it follows the movement of the gear stage in the event of rotation by the electric motor (not illustrated). The brake spring 25 is inserted into a non-rotatable sleeve 27. The brake spring 25 is activated by a control part which is formed from interlocking control inner part 28 and control outer part 29. The control outer part 29 surrounds the control inner part 28, while the brake spring 25 surrounds the control outer part 29. The drive arrangement is established such that the drive train is not self-locking but that the control outer part 29 causes the brake spring 25 to expand and form a frictional connection with the inner face of the sleeve 27 immediately after the electric motor is switched off. Forcible adjustment of the actuating element is also suppressed as a result. The brake spring 25 is designed and placed at such a point that adjustment is no longer possible even when external forces act on the actuating element. The diameter of the brake spring 25 corresponds to the diameter of the gear wheel with the largest diameter of a gear stage.

In the case of the actuating drives 10 under discussion, it is necessary to ensure that the actuating element and, respectively, the output drive element 22 of the drive train are moved into a predefined position in the event of a power failure. The actuating drive 10 is therefore in the form of a so-called spring return means and is equipped with a drive spring 30. This drive spring 30 may be, for example, a helical spring which, when the electric motor is switched on, is loaded or relieved of load depending on the direction of rotation of the output drive element 22 of the drive train. The arrangement has to be established such that it is relieved of load in the event of a power failure and return the output drive element 22 into the predifined position. For safety reasons, a plate 31 which is composed of an electrically insulating material, for example of plastic, still has to be arranged in the interior of the housing.

The invention is not restricted to the illustrated exemplary embodiment. It is important for the drive train which is formed from the individual spur gears 24 to not be self-locking, but for adjustment of the actuating element to be prevented by the brake spring 25 when the electric motor is switched off. The brake spring 25 is correspondingly activated by the control inner part 28 and the control outer part 29. Furthermore, it is important for the actuating drive to be in the form of a spring return means, so that the actuating element or, respectively, the output drive element of the drive train can be moved to a predefinable position by a drive spring 30 in the event of a power failure.

1. An electromotive actuating drive, for actuating elements, comprising: a housing in which an electric motor is connected by a drive train with an output drive element; the drive train being a non-self-locking drive train and having a plurality of gear stages; a manual adjusting shaft for adjusting the output drive element; with one of the gear stages being operatively connected with a brake element in such a way that at least that part of the drive train which leads from this gear stage to the output drive element is blocked from returning; and force storage means for driving the output drive element to a predetermined position in the event of a power failure.

2. An electromotive actuating drive according to claim 1, wherein the brake element is an expandable brake spring, which has a plurality of turns, and is operatively connected to a gear stage which is situated between the manual adjusting shaft and the output drive element of the drive train.

3. An electromotive actuating drive according to claim 1, wherein the brake element includes a brake spring coupled to the associated gear stage.

4. An electromotive actuating drive according to claim 3, wherein the brake spring has an associated non-rotatable sleeve with which it engages in a braking condition.

5. An electromotive actuating drive according to claim 3, wherein the brake spring surrounds a control part in such a way that the brake spring can be expanded after the electric motor is switched off.

6. An electromotive actuating drive according to claim 5, wherein the control part comprises a control inner part and a control outer part which surrounds the control inner part in an interlocking manner, and in that the brake spring surrounds the control outer part.

7. An electromotive actuating drive according to claim 3, wherein a diameter of the brake spring corresponds to a diameter of the gear wheel with the largest diameter of a gear stage.

8. An electromotive actuating drive according to claim 1, wherein the output drive element of the drive train has an associated potentiometer of flat construction.

9. An electromotive actuating drive according to claim 8, wherein the potentiometer of flat construction is a film potentiometer or a magnet potentiometer.

10. An eletromotive actuating drive according to claim 1, including electrical components are mounted to an end-face housing wall.

11. An eletromotive actuating drive according to claim 1, including electrical components mounted in an end-face housing wall which adjoins the electric motor and is situated opposite the output drive element.

12. An eletromotive actuating drive according to claim 10 wherein the end-face housing wall is a cover which is detachably fixed to the remaining housing.

13. An eletromotive actuating drive according to claim 12 including an intermediate piece arranged between the cover and the facing end faces of the housing parts.

14. An eletromotive actuating drive according to claim 10 wherein the electrical components include one or more of cable terminals, actuating devices, functional switches and ventilation stoppers.

15. An eletromotive actuating drive according to claim 1, wherein the housing includes a pair of housing parts that are of shell-like configuration.

16. An eletromotive actuating drive according to claim 15, wherein at least one housing part includes a projection of a shorter height extending in the direction of separating plane of the housing parts in the region of the output drive element of the drive train.

17. An eletromotive actuating drive according to claim 16, wherein the two housing parts project in the direction of the separating plane to the same extent.

18. An eletromotive actuating drive according to claim 16 including a centering and clamping apparatus, which is connected to the output drive element of the drive train in an interlocking manner, is arranged in the region of the housing part projections.
